(19) United States
(12) Patent Application Publication
(10) Pub. No.: US 2009/0213836 A1
(43) Pub. Date: Aug. 27, 2009

(54) WEB PAGE TELEPHONE SYSTEM

(75) Inventors: Wen-Chih Tsai, Taipei (TW); Chung-Hu CHAO, Taipei (TW)

Correspondence Address: LANDO & ANASTASI, LLP, ONE MAIN STREET, SUITE 1100, CAMBRIDGE, MA, 02142, US

(73) Assignee: HW Internet Telephone & Telecommunication Co., Ltd, Majuro (MH)

(21) Appl. No.: 12/036,776

(22) Filed: Feb. 25, 2008

(51) Int. Cl. H04L 12/66

(52) U.S. Cl. 370/352

(57) ABSTRACT

A web page telephone system uses a web page information processor to connect to telecommunication exchanges of a VoIP network and is built in with the registration data and link files for web page owners. Each of the link files corresponds to a contact label on a web page belong to the web page owner. The contact label establishes a link with the web page information processor. When any end user uses a computer browser to link to and display the web page, the link file is activated by clicking the contact label. The web page information processor completes automatic identification and finds the corresponding telecommunication exchange. Once the end user's computer sends out a dial request, the telecommunication exchange is notified to establish a VoIP network connection between the communication device of the web page owner and the end user computer.

### BACKGROUND OF THE INVENTION

1. Field of the Invention

The invention relates to a web page telephone system and, in particular, to a telephone system that allows users to have telecommunications via a web page.

2. Description of Related Art

With the network over the world, Voice Over Internet Protocol (VoIP) network becomes very useful. In particular, it is very cost-effective for the users. According to statistics, people save about 40% by using network telecommunications instead of through the usual telecommunication service providers.

Early Public Switch Telephone Network (PSTN) service providers provide wired telecommunications services so that people can make local or international phone calls. Nowadays, due to the mature wireless communication technology and based upon business considerations, governments of various countries start to allow wireless telecommunications providers. The wireless service providers organize and set different telecommunication rates for the users to select. Recently, in addition to free calls within the same network, the network telecommunications service providers even lower the rates for local or mobile phone calls by exploiting the free bandwidths of the VoIP network.

With reference to FIG. 6, the VoIP network providers rent multiple communication channels from upstream telecommunications providers. In other words, the VoIP network providers uses a host 70 connecting to the server host 80 of an upstream telecommunications provider for managing and transferring phone calls of its users 71. The connections between callers and receivers are thus established. If the host 70 determines that a phone call is within the network, then there is no charge for the phone call. If the telephone number from the VoIP network (receivers) belongs to a local phone or a mobile phone and the communication has to gone through a host of the PSTN service provider or the wireless communications service provider, then the user will be charged. But the charge is still cheaper than directly through the PSTN or wireless base stations.

Although the network transfer system as shown in FIG. 6 can reduce the charges on both parties for local or mobile phone calls, both the caller and the receiver are still charged for the telecommunications. Moreover, computer users have to download some telecommunication software in order to use the VoIP network function. In a dialing interface of the telecommunication software, the user has to enter or set a VoIP network number in order to communicate with the PSTN or mobile phone users. Therefore, such a network transfer system is still inconvenient in use.

Currently, some VoIP network providers are promoting web page telephones for computer users. Such a technology utilizes the prevailing Internet and popular communication platforms. A user is first asked to register at the host of the VoIP network service provider and obtains a user account. The host then provides a dialing web page for the user to browse. Afterwards, the user selects a VoIP network displayed on the web page. At this moment, the host asks the user to enter his user account and password. Once they are confirmed, the host connects the user's computer with the communication device of the other party. However, this operating method is still inconvenient.

As online shops and online diaries have made a lot of progress recently, how to more effectively enlarge their online community is an important issue. Combining with the web page telephone system is a new choice for the network users to communicate more directly and frequently.

### SUMMARY OF THE INVENTION

An objective of the invention is to provide a web page telephone system so that network users can readily set network telecommunication functions on the web page. The users browsing the web page can directly click the network telecommunication function on his computer, so that he can conveniently communicate using the computer.

To achieve the above-mentioned objective, the web page telephone system has a web page information processor, at least one web page server and a plurality of user computers.

The web page information processor is connected with a plurality of telecommunication exchanges in a VoIP network system. It stores a plurality of web page user data and link files. Each of the link files is built in with the identification data, web page information processor web address, and contact phone number of the corresponding web page user. The web page information processor is built in with an active dialing procedure.

The web page server is connected with the web page information processor to provide a web page. The web page contains a contact label corresponding to the link file stored in the web page information processor for establishing a network connection.

The user computers are connected to the web page servers to display the currently linked web pages. Moreover, each of the user computers contains a microphone and a speaker.

The invention allows each web page user to register at the web page information processor for obtaining a link file. The link file contains the web page user's identification data and the web address of the web page information processor. When the user's computer is linked to the web page server to display and browse the web page, he is able to click the contact label thereon. After that is done, the user's computer activates its link file to link with the network information processor. The network information processor searches for the network telecommunication exchange address corresponding to the web page user's registered telephone number. Afterwards, it notifies the network communication exchange so that a connection can be established between the web page user's communication device and the user's computer.

Another objective of the invention is to provide a speed-dialing web page telephone system. Each of the link files stored in the above-mentioned web page information processor further contains the contact telephone number of the web page user. Once the signal of opening the link file on the web page is received from the user's computer, the network telecommunication exchange address corresponding to the web page user's registered telephone number will be located. After receiving the communication request made by the user's computer subsequently, it is immediately linked with the telecommunication exchange. Through the connection of the telecommunication exchange, a VoIP network connection is established for the web page user's communication device and the user's computer.

### BRIEF DESCRIPTION OF THE DRAWINGS

FIG. 1 is a framework of a web page telephone system in accordance with the present invention;

FIG. 2 is a flow chart of a registering procedure in accordance with the present invention;

FIG. 3 is a flowchart of an active dialing procedure in accordance with the present invention;

FIG. 4 is a flowchart of the web page telephone system in accordance with the present invention;

FIGS. 5A and 5B are schematic views of execute screens on the user's computer; and

FIG. 6 is a framework of an existing system used for VoIP network providers.

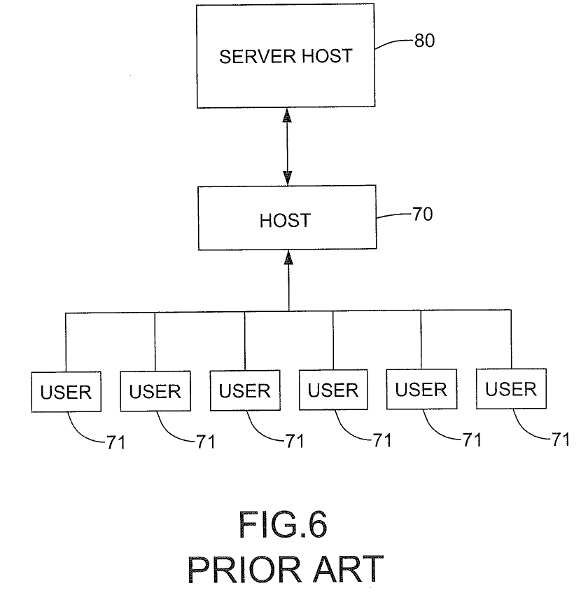

### DETAILED DESCRIPTION OF THE PREFERRED EMBODIMENT

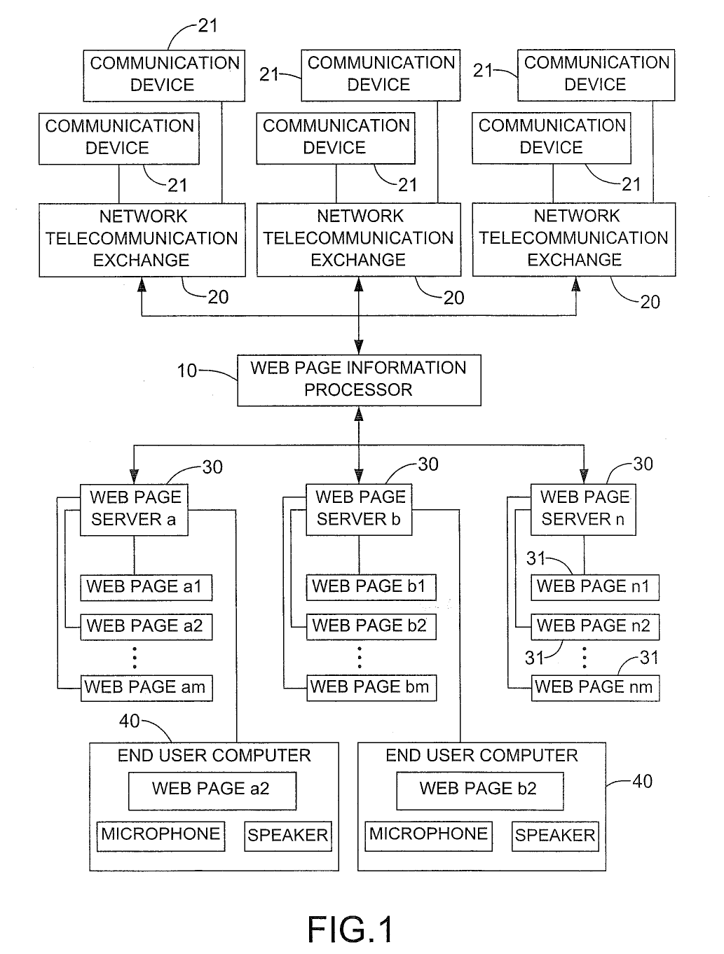

With reference to FIG. 1, the web page telephone system in accordance with the present invention comprises a web page information processor 10, a plurality of network telecommunication exchanges 20, at least one web page server 30 and a plurality of end user computers 40.

The web page information processor 10 is in communications with the network telecommunication exchanges 20 of a Voice Over Internet Protocol (VoIP) network. The web page information processor 10 stores multiple web page owner data and link files. Each of the link files contains identification data corresponding to a web page owner, an address of the web page information processor 10, and a contact phone code. The contact phone code corresponds to the contact phone number of the personal communication device 21. The web page information processor 10 is built in with an active dialing procedure.

Each of the network telecommunication exchanges 20 in the VoIP network system stores contact phone numbers of the web page owners and addresses of other network telecommunication exchanges 20. Therefore, each of the network telecommunication exchanges 20 can communicate with other network telecommunication exchanges 20.

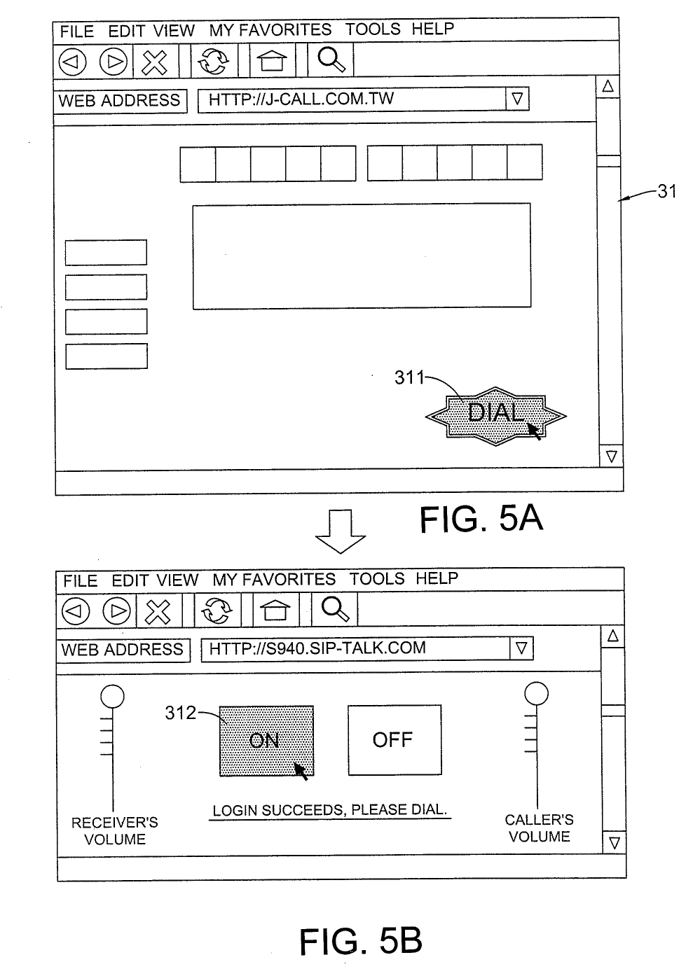

With further reference to FIG. 5A, the web page server 30 is connected with the web page information processor 10 to provide web pages 31. The web page 31 is owned by the web page owner and has a contact label 311. The contact label 311 corresponds to one of the link files in the web page information processor 10 for establishing network connections.

The plurality of end user computers 40 are connected to the web page servers 30 individually to display the web pages 31. Moreover, each end user computer 40 has a microphone and speaker.

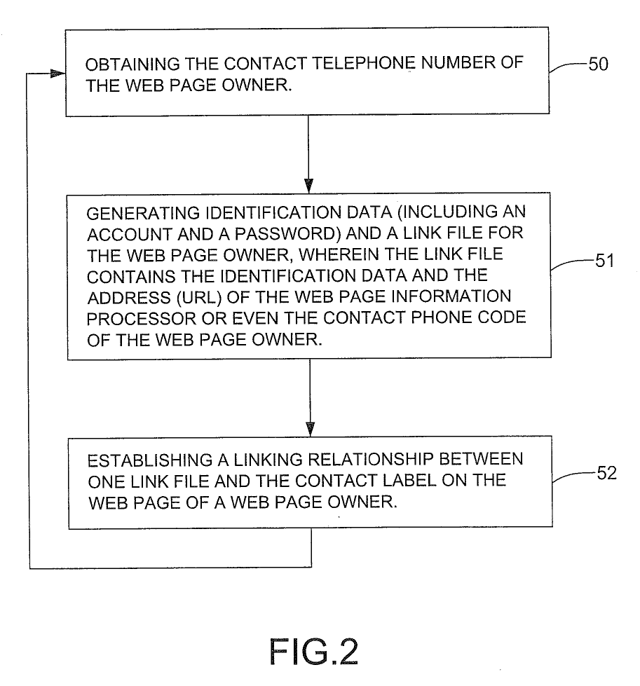

With further reference to FIG. 2, the registering procedure of the web page information processor 10 for the web page owners includes the steps of:

obtaining a contact telephone number of the web page owner (step 50);

generating identification data (including an account and a password) and a link file for the web page owner, wherein the link file contains the identification data and the address (URL) of the web page information processor 10 or even the contact phone code of the web page owner (step 51); and

establishing a linking relationship between one link file and the contact label 311 on the web page 21 of a web page owner (step 52).

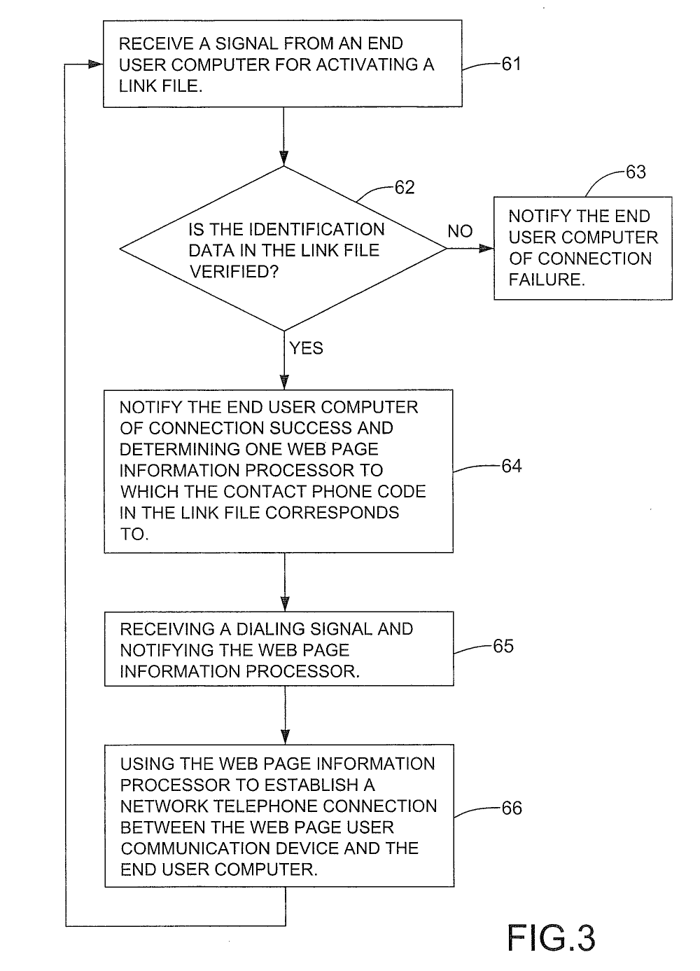

With further reference to FIG. 3, the active dialing procedure includes the steps of:

receiving a signal from the end user computer 40 for activating a link file (step 61);

verifying the identification data in the link file, and executing the following steps if the identification is verified (step 62) or notifying the end user computer of connection failure if not (step 63);

notifying the end user computer 40 of connecting success, determining one web page information processor 10 to which the contact phone code in the link file corresponds to and waiting for a dialing signal from the end user computer 40 (step 64);

receiving the dialing signal from the end user computer 40 and notifying the web page information processor 10 (step 65);

using the web page information processor 10 to establish a VoIP network connection between the web page user communication device 21 and the end user computer 40 (step 66).

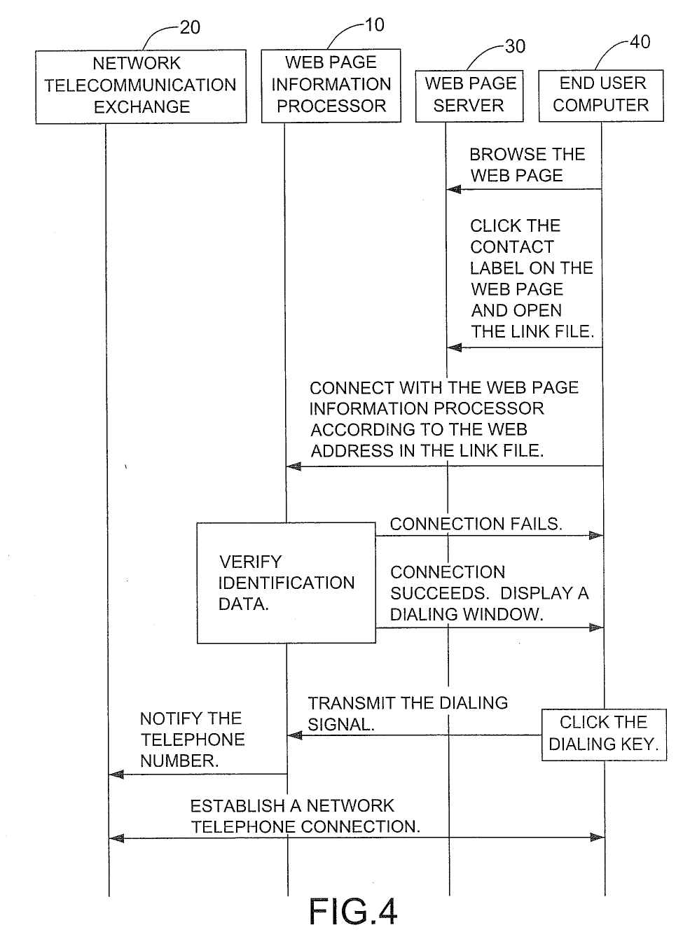

With further reference to FIGS. 4, 5A, and 5B, an example is used to explain the web page dialing procedure for the web page telephone system in accordance with the present invention.

Suppose an end user uses a computer 40 to browse a web page 31 of a web page server 20. If the end user wants to communicate with a web page owner, the end user can click the contact label 311 on the web page 31. Since the contact label 311 is associated with a link file, the contact label 311 is linked to the web page information processor 10 according to the web address (URL) in the link file. When the web page information processor 10 is notified that a corresponding link file is activated, the web page information processor 10 reads the corresponding built-in link file and verifies the web page owner's identity (e.g., determining whether the web page owner' is a valid customer and payer). At the same time, the web page information processor 10 searches for a network telecommunication exchange 20 corresponding to the contact phone code in the link file. If the verification has failed, the web page information processor 10 notifies the end user computer 40 of connection failure. If the connection is successful, a dialing window is shown on the browser on the end user computer 40 as shown in FIG. 5B. After the user clicks a dialing link 312 on the dialing window, the web page information processor 10 notifies the network telecommunication exchange 20 to establish a VoIP network connection between the communication device 21 of the web page owner and the end user computer 40.

According to the invention, the web page owner possessing an online shop or an online diary can register at a web page information processor to establish a contact label. When any end user uses his or her computer to connect to a web page of the online shop or online diary, the end user can directly click the contact label. In this case, the end user's computer actively connects to the web page information processor. Once the web page information processor verifies the identity, it immediately transfers to the network telecommunication exchange, establishing a connection between the end user's computer and the web page owner. Therefore, not only can the invention provide a convenient and expanded communication channel between the web page user and his or her consumers or friends, it further enables general consumers to easily communicate with online shops or friends online. It avoids complicated steps for dialing or downloading network communication software. Moreover, the user does not need to pay. Instead, only the web page user pays the web page information processor service provider.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A web page telephone system comprising:
a web page information processor connected to a plurality of telecommunication exchanges of a voice over IP (VoIP) network, stored with identification data of web page owners and multiple link files and built in with an active dialing procedure, each of the link files having the identification data for each web page owner, a web address of the web page information processor, and a contact phone number of the corresponding web page owner;
at least one web page server connected with the web page information processor for providing a web page containing a contact label, the contact label corresponding to one of the link files stored in the web page information processor for establishing a network connection; and
a plurality of end user computers connected to the web page servers to display the currently linked web pages, each of the end user computers having a microphone and a speaker.

2. The web page telephone system as claimed in claim 1, wherein the web page information processor has a registering procedure comprising the steps of:
generating identification data and a link file that contains the identification data and the web address of the web page information processor; and
establishing a linking relationship between the link file and the contact label on the web page of a web page owner.

3. The web page telephone system as claimed in claim 2, wherein the identification data comprise an account and a password for the web page owner and each of the link files further has a contact phone code corresponding to the contact phone number of the web page owner.

4. The web page telephone system as claimed in claim 3, wherein the active dialing procedure includes the steps of:
receiving a signal from the end user computer for activating a link file;
verifying the identification data in the link file, and executing the following steps if the identification is verified or notifying the end user computer of connection failure if not;
notifying the end user computer of connecting success, determining one web page information processor to which the contact phone code in the link file corresponds to and waiting for a dialing signal from the end user computer;
receiving the dialing signal from the end user computer and notifying the web page information processor;
using the web page information processor to establish a VoIP network connection between the web page user communication device and the end user computer.

5. The web page telephone system as claimed in claim 4, wherein the telephone number of the web page owner is a network phone number, a Public Switch Telephone Network (PSTN) phone number, or a mobile phone number.
